(19) United States
(12) Patent Application Publication
(10) Pub. No.: US 2011/0217020 A1
(43) Pub. Date: Sep. 8, 2011

(54) Mobile Movie Editing System

(75) Inventors: Kenneth S. Bailey, San Jose, CA (US); Christopher Carmichael, (US)

(73) Assignee: Ubiquity Holdings

(21) Appl. No.: 11/852,135

(22) Filed: Sep. 7, 2007

Related U.S. Application Data
(60) Provisional application No. 60/844,214, filed on Sep. 12, 2006.
(60) Provisional application No. 60/886,266, filed on Jan. 23, 2007.

(51) Int. Cl. G11B 27/02

(52) U.S. Cl. 386/278; 386/E05.028

(57) ABSTRACT

Editing mobile phone style-obtained movies on a remotely-accessible website. Mobile movies are obtained by a thin clients such as a cellular phone. The movies can be uploaded to a website and then edited on the website, via an interface that is accessible from the mode mobile phone.

### CROSS-REFERENCE TO RELATED APPLICATIONS

This application claims priority to U.S. Provisional Applications 60/844,214, filed Sep. 12, 2006 and 60/886,266, filed Jan. 23, 2007. The disclosure of the prior applications are considered part of (and are incorporated by reference in) the disclosure of this application.

### BACKGROUND

Roving reporters try to be in the right place at the right time to get a news scoop before their peers. These news crews often deploy portable satellite dishes to send their reports back to a news headquarters.

Cellular phones create the opportunity for anyone to be a roving reporter. News networks in fact advertise requesting people to send their images and videos. Images and videos can also be posted on websites such as U Tube and My Space.

### SUMMARY

The present inventor recognized that videos from such devices are typically raw, and that a carefully edited video from a mobile device may be much more popular.

The present application describes interlinking software that can be downloaded to a cell phone, which allows editing video clips.

### BRIEF DESCRIPTION OF THE DRAWINGS

FIG. 1 illustrates a block diagram.

### DETAILED DESCRIPTION

The general structure and techniques, and more specific embodiments which can be used to effect different ways of carrying out the more general goals, are described herein.

According to one embodiment, the software allows uploading the video clip to a special website on the host computer, making necessary changes to the clip, and then downloading and storing the edited results. The edited results can be sent directly from the website, or can be viewed on the cell phone and sent in the normal way from the cell phone. Moreover, it becomes possible for a first user to obtain the video, and for a second user to edit the video and send the edited video back to the original video obtainer.

For example, a user who is in the middle of some activity can take a video of that activity, and send the video to a friend who can edit it. The friend then sends the edited video back to the original user.

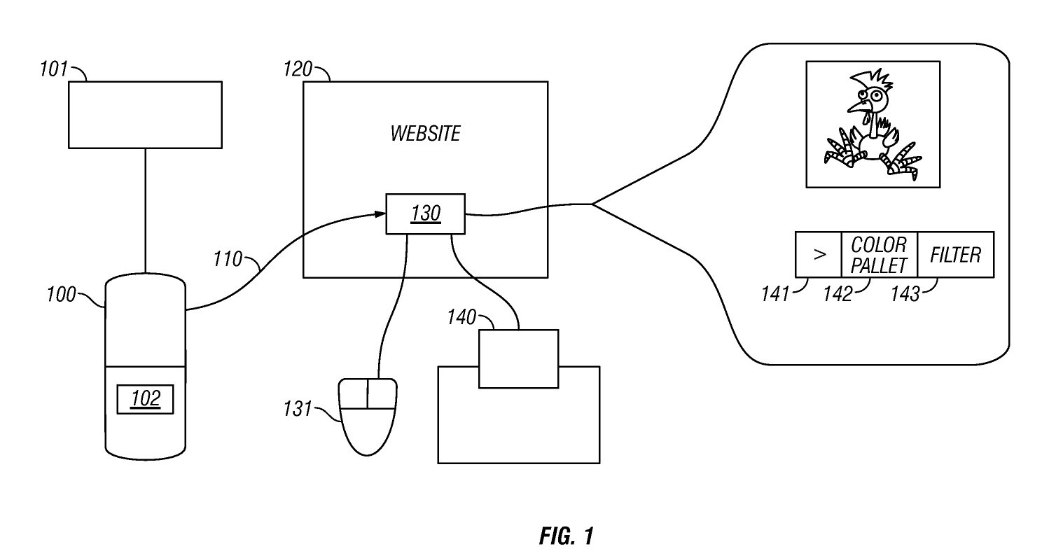

FIG. 1 illustrates a block diagram. The portable phone 100 takes a video of the scene shown generally as scene 101. At least part of the video is stored within an internal memory 102, and the video is sent over a channel 110 to an editing website 120. That editing website has special editing tools for editing the videos. The videos as edited will preferably maintain their native format, but may also be transcoded to have a different pixel rate, different refresh rate, or the like.

The website 120 stores the video and allows interaction with a number of video tools shown generally as 130. Anyone who can connect to the website can interact with these tools. For example, the connection can be via a cell phone shown as 131. This may be the same cell phone as 100 (that obtained the video), or may be a different cell phone. Another interaction can be via a computer terminal 140. 130 produces a graphical user interface of the video, which allows various operations on the video. The video can be reviewed frame by frame, using a selection of the forward button, 141, which allows viewing the video one frame at a time. The video can also be color-corrected using a color palette shown as 142. The video can be filtered using a number of different filters shown as 143 including sharpening filters, as well as other kinds of filters such as noise reducing filters. In general, any video editing operation can be carried out using the video tools 130.

The video clips can be from any enabled device, such as a cellular device, PDA, iPod, or other. These devices can download, upload and edit short video clips. The video clips are typically under four minutes in duration, but can be of any desired length. The clips can be sporting events, natural catastrophes, acts of God, or any clips that others may find interesting.

In an embodiment, the raw video data is processed to separate the action part of the video from the background of the video. For example, the background of the video may be relatively constant. The action part of the video is so-called talking heads formed of images like a newscaster presenting the news. The background images may move such as in a car chase or skiing event, or may remain relatively still such as when a newscaster is speaking.

According to a technique, movement of pixels in macro blocks is measured. Each macro block may be a 4×4; 8×8 or 16×16 groups of pixels. A common intermediate format (CIF) frame has 12 macro blocks, and a quarter CIF frame has 144 lines with 176 pixels per line. Each block is analyzed to see if it includes motion or does not include motion. The parts that do not include motion are simply less unchanged, since the low resolution display on the cell phone will likely not be effected. However, the parts that include motion are continually updated.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other thin clients may be used in place of cellular phones, such as PDAs etc.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method, comprising:
obtaining a video with a portable device;
uploading said video to be edited on a website;
allowing editing, on said website, via remote access to said website, said allowing editing allowing access to tools to edit said video using controls on said website; and
after said editing, sending said video from said video to said portable device.

2. A method as in claim 1, further comprising
dividing said video into motion-including parts, and background parts that do not include motion, and
updating the motion including parts and not updating the background parts.

3. A method as in claim 1, further comprising allowing said editing from the portable device that obtained the video.

4. A method as in claim 1, further comprising allowing said editing from a different portable device from the one that obtained the video.

5. A method, comprising:
obtaining a video with a portable device;
uploading said video to be edited on a website;
allowing editing, on said website, remote access to said website, and access to tools to edit said video using controls on said website; and
after said editing, sending said video from said video to another portable device different than said portable device that obtained said video.

6. A method as in claim 5, further comprising
dividing said video into motion-including parts, and background parts that do not include motion, and
updating the motion including parts and not updating the background parts.

7. A method as in claim 5, further comprising allowing said editing from the portable device that obtained the video.

8. A method as in claim 5, further comprising allowing said editing from said another portable device.
